(19) United States
(12) Patent Application Publication
(10) Pub. No.: US 2009/0282909 A1
(43) Pub. Date: Nov. 19, 2009

(54) Film Resistor in Exhaust-gas Pipe

(75) Inventors: Karlheinz Wienand, Aschaffenburg (DE); Karlheinz Ullrich, Gross-Umstadt (DE); Matthias Muziol, Mainhausen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HERAEUS SENSOR TECHNOLOGY GMBH, Hanau (DE)

(21) Appl. No.: 12/307,024

(22) PCT Filed: Jun. 29, 2007
(86) PCT No.: PCT/EP07/05769

§ 371 Date: Mar. 24, 2009

(30) Foreign Application Priority Data
Jun. 30, 2006 (DE) 102006030786.0

(51) Int. Cl. G01F 1/692; H01C 17/00

(52) U.S. Cl. 73/204.26; 29/610.1

(57) ABSTRACT

A measurement device, in particular anemometric measurement device of a flow sensor, contains film resistors in one or more opening(s) of a cover or a hollow body. The film resistors are fastened according to the invention in the opening(s). Two film resistors differ with respect to their resistance by one to three orders of magnitude.

In an anemometric measurement device of a flow sensor according to the invention, a temperature sensor and a heating capacity sensor are placed in a carrier element. The temperature sensor has a temperature-measuring resistor and a heat conductor as platinum thin-film or thick-film resistors on a ceramic substrate.

For self-cleaning of an anemometric measurement device of a flow sensor, in which a temperature-measuring element and a heating element are placed in a carrier element, the temperature-measuring element has a platinum thin-film resistor on a ceramic substrate for temperature measurement and is heated with an additional platinum thin-film resistor.

For production of an anemometric measurement device of a flow sensor made of film resistors and a cover or a hollow body, two film resistors differing by one to two orders of magnitude are placed in openings of the cover or hollow body and are fastened in the openings.

The invention relates to a flow sensor element having film resistors, in particular having a temperature sensor based on a platinum thin-film resistor and a heating capacity sensor based on a platinum thin-film resistor. Preferably, the temperature sensor and the heating capacity sensor are arranged on a carrier element. Electrical conductor tracks and terminal pads for the electrical contacting of temperature sensors and heating capacity sensors arranged on a ceramic substrate have proven to be effective. In addition, the invention relates to the production and application of such a flow sensor element, in particular in a device for exhaust-gas recirculation.

Such flow sensor elements are known from EP 1 065 476 A1. There, a thermal air flow sensor is disclosed in which a sensor element having a heating resistor and a resistance temperature-measuring element is arranged countersunk in a recess of a ceramic laminate body and fixed with ceramic cement. Due to the adhesive bond and the countersunk arrangement of the sensor element with or in the ceramic laminate, the sensor element has a marked reaction inertia to temperature changes in the measurement medium. The electrical contacts are covered in the flow region with an epoxy resin, so that use of the device at temperatures above 300° C. is not possible. In addition, the arrangement is complicated and therefore cost-intensive.

DE 102 25 602.0 discloses a temperature sensor having a total thickness of 10 to 100 μm, which has a metallic film substrate with an electrically insulating coating on which a platinum thin-film resistor is arranged as a temperature-sensitive element. The temperature sensor is used in the region of a cooling body for a semiconductor component.

DE 195 06 231 A1 discloses a hot-film anemometer having a temperature sensor and a heating capacity sensor. The heating capacity sensor is arranged like a bridge in a recess of a plastic carrier plate. The platinum-temperature-thin-film elements for the temperature sensor and the heating capacity sensor are arranged on a ceramic substrate, which is preferably formed from aluminum oxide.

DE 199 41 420 A1 discloses a sensor element for temperature measurement on a metallic substrate, which has an insulation film as a membrane. Here, the membrane spans a recess in the metallic substrate. The platinum thin film is here arranged in the region of the recess on the membrane.

DE 101 24 964 A1 discloses a sensor for measurement of flow velocities of gases or liquids with a carrier membrane, which is constructed in the form of a ply. The carrier membrane is preferably formed from a plastic and has an electric conductor track made of platinum and electrical feed lines. The use of such a sensor with a carrier membrane made of plastic is not possible at temperatures above 300° C.

EP 1 431 718 discloses a quick-response flow sensor element for measuring mass flows of hot gaseous or liquid media. For this purpose, a temperature-measuring element and a heating element each have a metallic carrier film with an electrically insulating coating, on which the platinum thin film resistors are arranged. Upon contamination, the measurement value drifts.

DE 199 59 854 describes an exhaust-gas recirculation system, in which the inflowing air is measured with a flow mass sensor according to the anemometric principle and a second flow mass sensor is arranged after a water cooling system in the exhaust gas channel for the measurement of the exhaust gas quantity.

It is now an object of the invention to suitably arrange flow sensors in exhaust-gas recirculation systems for mass production, preferably also to counteract drift, in particular to clean a corresponding flow sensor element or to keep functionally stabile a flow sensor element, which is exposed to a large amount of contamination, such as, e.g., exhaust gas.

The is achieved with the features of the independent claims.

Preferred embodiments are described in the dependent claims.

According to the invention, an anemometric measurement device is provided for flow sensors in which film resistors are fastened in a cover or a hollow body in an opening or in openings of the cover or hollow body, wherein two resistors differ by one to three orders of magnitude.

The film resistors comprise at least one conductor track, in particular made of platinum, preferably a platinum thin-film conductor track on a substrate, in particular a ceramic plate, and for each conductor track, two terminal lines connected to the conductor track.

The resistor, which is larger by one to three orders of magnitude is suitable as a temperature-measuring resistor and is designated as such below. The resistors that are smaller by one to three orders of magnitude relative to the temperature-measuring resistor are suitable for heating. With respect to these heating resistors, in the scope of the present invention, various functions are to be distinguished:
1. Heating resistors for self-cleaning of the temperature sensor as a component of the temperature sensor.
2. Heating resistors as heating capacity sensors for determining a mass flow according to the anemometric principle.

Heating capacity sensors with two heat conductors allow the direction of mass flow to be determined. Heating capacity sensors with an additional temperature-measuring resistor allow a precise temperature setting of the heating capacity sensor. The present invention here relates exclusively to film resistors constructed as thick-film or thin-film resistors, preferably in platinum, in particular as platinum thin-film. The film resistors are arranged on a carrier material, in particular on a ceramic substrate. The ceramic substrate can be constructed as a carrier or arranged on a carrier, as e.g., a metal plate. In terms of terminology, film resistors mounted on a carrier material are also designated as film resistors, so that linguistically there is no difference between film resistors in the strict sense as the pure resistive film and film resistors including the carrier material. The film resistors placed in openings of a cover or hollow body comprise the carrier material on which the thinner thick film is arranged as the resistive layer.

In the preferred construction, the film resistors are arranged, in the strict sense, on a ceramic substrate. Different film resistors can be arranged, in the broad sense, one next to the other in an opening of a cover or hollow body or separately each in an opening. Preferably, heating capacity sensors and temperature sensors are spaced apart from each other. Two heat conductors of a heating capacity sensors are preferably arranged one behind the other so that they lie one behind the other in the direction of flow. Heating capacity sensors are constructed with two heat conductors on a common substrate or with two identical chips arranged one after the other.

The openings of the cover or hollow body are advantageously slots or boreholes.

The cover is provided for forming a sealed closure of a tube. If the cover is made of metal, it can be welded to a metal tube. The film resistors are guided, in the broad sense, through the opening or the openings of the cover and mounted in the opening or in the openings on the cover. The hollow body is used for receiving the terminals of the film resistors whose sensitive part projects out from the hollow body through the opening or the openings.

A significant aspect of the present invention is that resistors generated with thick or thin films are integrated into a sensor element that can be easily assembled in an exhaust-gas channel in mass production. The solution according to the invention to place film resistors in a cover or hollow body allows a simple sealing of the cover or hollow body both with respect to the carrier material of the resistors and also the material of the exhaust-gas channel.

According to the invention, it is achieved that the film resistors can be constructed perpendicular to the base surface of a cover or hollow body. This produces production-related advantages relative to an arrangement fed in parallel to a plate. Here, the invention is not limited to a vertical construction, but instead allows an arbitrary angle to the surface of the cover or hollow body. As an essential inventive advantage, the vertical component of angles can be constructed according to the present invention. Accordingly, the advantage of the present invention occurs especially at angles of 60 to 90 degrees, particularly 80 to 90 degrees.

In preferred embodiments:
the hollow body is open on one side or is constructed as a tube;
the cover is constructed as a disk;
the base surface of an opening for receiving at least two film resistors is at least one order of magnitude smaller than the cover base surface or a corresponding hollow body base surface;
the cover or the hollow body has two openings for receiving film resistors;
the cover is made of ceramic material;
the film resistors held on ceramic carrier material are fixed in the opening of a ceramic cover, in particular a ceramic disk with glass solder;
the film resistors carried on a ceramic substrate are fixed in at least one opening of a metal cover or hollow body, in particular a metal disk welded on a metal tube with sealing compound or glass.

The measurement device according to the invention is suitable for flow sensors or soot sensors.

The flow sensor element is operated with the film resistors according to the anemometric principle. According to the invention, a temperature sensor is equipped with a heat conductor as part of an anemometric measurement device. In this way, the temperature sensor can be cleaned by annealing with a heater. It has proven to be effective to decouple the temperature sensor in the anemometric measurement device and the heating capacity sensor to be distinguished from the heater of the temperature sensor, preferably to space these sensors apart, in particular to place them in separate openings of the cover of hollow body. The temperature sensor has a significantly larger resistor than the heater, typically one to three orders of magnitude larger.

Self-cleaning of the temperature sensor or its temperature-measuring element by annealing is made possible by a heat conductor. In particular, this heat conductor is integrated on the chip of the temperature-measuring element. In a preferred embodiment at least two platinum thin-film resistors are arranged on a ceramic carrier plate. This allows heating of the temperature-measuring element for baking off or annealing contaminants. In particular, the two resistors of the temperature-measuring element are arranged on a ceramic substrate, preferably on a substantial ceramic plate.

Instead of a ceramic carrier, the resistors can also be arranged on a ceramic substrate on an alternative carrier.

To be distinguished from the temperature sensor is a temperature-measuring resistor, optionally arranged on the heating capacity sensor, and with which the temperature of the heat conductor can be adjusted in an especially precise way. In contrast to the temperature sensor, a complete temperature-measuring resistor is not provided for the measurement of the fluid temperature, because it is suitable only for its temperature control during the operation of the heating capacity sensor.

It has proven to be effective to construct the carrier of the platinum thin film resistors as thin plates, resulting in an extremely low thermal inertia of the system and thus a high response rate of the platinum thin film resistors. For forming a ceramic composite, sintered ceramic films can be used that are then adhered, preferably with a glass solder. The materials used for the construction of the flow sensor element can be best used at temperatures in the range of −40° C. to +800° C.

Here it is especially preferred if the ceramic carrier plates have a thickness in the range of 100 μm to 650 μm, in particular 150 μm to 400 μm. As a material for the ceramic carrier plate, Al₂O₃ has proven to be effective, in particular with at least 96 wt. % and preferably greater than 99 wt. %.

For platinum thin-film resistors, it has proven to be effective if these each have a thickness in the range of 0.5 μm to 2 μm, particularly 0.8 μm to 1.4 μm. Heating resistors preferably have 1 to 50 Ohm and tend toward lower values for reducing the size of the components. At currently common dimensions of the components, 5 to 20 Ohm is preferred. Temperature-measuring resistors preferably have 50 to 10,000 Ohm and also tend toward lower values for reducing the size of the components. At the currently common dimensions of the components, 100 to 2000 Ohm are preferred. On the temperature chip the temperature-measuring resistor is larger by a multiple than the heating resistor. In particular, these resistors differ by one to two orders of magnitude.

In order to protect the platinum thin-film resistors from corrosive attack by the measurement medium, it has proven to be effective if these are each covered with a passivation layer. The passivation layer here preferably has a thickness in the range of 10 μm to 30 μm, in particular 15 μm to 20 μm. A passivation layer made of at least two different individual layers has proven to be effective, in particular individual layers made of Al₂O₃ and glass ceramic. The thin-film technology is suitable for generating the preferred layer thickness of the Al₂O₃ layer of 0.5 μm to 5 μm, particularly 1 μm to 3 μm.

It is also preferred if the at least one heating elements has rectangular ceramic carrier plates with two long and two narrow edges and if the ceramic carrier plates are arranged in openings of a cover or a hollow body.

The platinum thin-film resistors are here preferably arranged on the end of the carrier plate facing away from the cover or hollow body, in order to guarantee the smallest possible thermal influence of the platinum thin-film resistors by the heat-bearing cover or hollow body.

To prevent a mutual influence of the temperature-measuring element and heating element, it is advantageous if the platinum thin-film resistor of the heating element is arranged farther away from the cover or hollow body than the platinum thin-film resistor of the temperature-measuring element. Therefore, the platinum thin-film resistors of the heating element are not arranged in the same flow segment of the measurement medium as the platinum thin-film resistors of the temperature-measuring element.

The preferred arrangement of the temperature-measuring element is in front of the heating element in the direction of flow.

Preferably, the carrier plates of the heating element and the temperature-measuring element are spaced apart from each other, and indeed particularly parallel to each other.

It has proven to be effective if two heating elements and a temperature-measuring element are arranged in series, particularly for measuring media with changing flow direction.

It has proven to be effective to arrange the carrier plates of the heating element and of the temperature-measuring element in the cover or hollow body spaced apart from each other and parallel to each other.

With the flow sensor element according to the invention a mass through-flow measurement of gaseous or liquid media in pipelines is made possible, particularly when the carrier plates are arranged in the direction of flow of the medium.

Here, the flow sensor element according to the invention is suitable particularly for measuring gaseous media having a temperature in the range of −40° C. to +800° C., as it has, for example, with the exhaust gas of an internal combustion engine.

The self-cleaning by heating the temperature-measuring element is especially suitable for sensors arranged in the exhaust gas region of internal combustion engines, particularly diesel engines. Sooty sensors are quickly made fully functional again by heating, particularly annealing. Here, this self-cleaning can be repeated as often as needed during the service life of an engine.

The arrangement of several temperature-measuring elements and heating elements on the carrier element ideally also makes possible the identification of the direction of flow or changes in the direction of flow of a medium. In this respect, it is advantageous to use the flow sensor element according to the invention for measuring media with a direction of flow changing at time intervals.

With the measurement devices according to the invention, devices for exhaust-gas recirculation can be realized, in which the measurement device is arranged in the outlet region of a vehicle internal combustion engine. Surprisingly, more precise measurement results can be achieved in the measurement of the hot exhaust gas according to the invention, so that according to the invention the exhaust gas is measured practically without cooling before a cooler or optionally within an air cooler. For this purpose, a measurement device according to the invention is needed that withstands the hot exhaust gases for a long time.

Thus, a device is provided for exhaust-gas recirculation from an outlet region of a vehicle internal combustion engine into an air inlet region, to which an adjustable mixture of exhaust gas and inflowing air of the machine can be fed, and a fuel quantity can be adjusted, in which, according to the invention, in the outlet region a hot-film anemometer is arranged, in particular the outlet region is connected via an exhaust-gas recirculation line having a controllable valve, an exhaust-gas cooling device, and a hot-film anemometer, to an inlet region of the internal combustion engine, wherein the hot-film anemometer 1 has two ceramic chips fastened on a ceramic carrier, and the transition to the metallic material of the exhaust-gas outlet region of the internal combustion engine is realized on this carrier, so that the current path of the chip is insulated electrically and gas-tight by the ceramic material from the metallic material in the region of the exhaust-gas outlet region of the internal combustion engine.

Preferably, the hot-film anemometer 10 is arranged in an exhaust-gas recirculation channel before the cooling device 8 or in an air-cooled cooler.

According to the invention, a hot-film anemometer 10 need not be arranged either for the fresh air or for the cooled exhaust gas.

A device has proven to be effective in which the temperature-measuring element has two platinum thin-film resistors, whose resistors lie apart from each other by a multiple.

In particular, the multiple-part ceramic component of the hot-film anemometer comprises a carrier element, a temperature-measuring element, and a heating element.

A device has proven to be effective in which two film resistors 128, 129 are held in an opening on a common ceramic substrate 107.

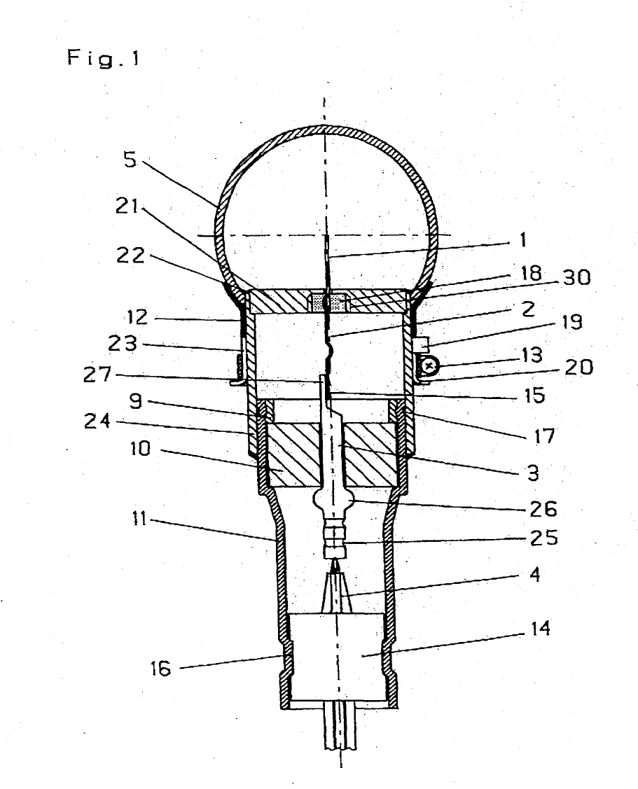

FIGS. 1 to 3b explain the flow sensor element according to the invention merely as an example. Here it should therefore be explicitly added that the arrangement of the electrical conductor tracks and terminal pads, as well as the number of platinum thin films per temperature-measuring element or heating element can also be selected differently without departing from the scope of the invention.

FIG. 1 shows a flow sensor element having heat- and temperature-measuring elements arranged in a metal disk;

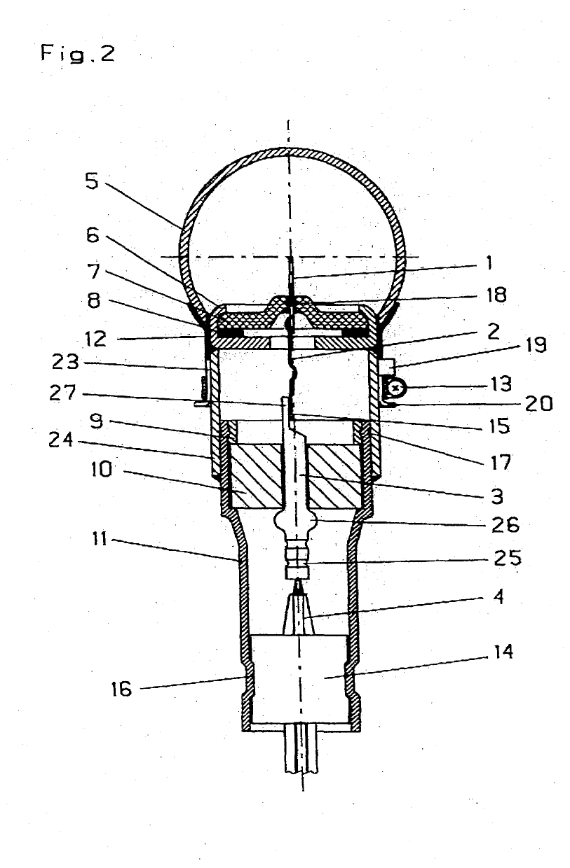

FIG. 2 shows a flow sensor element having heat- and temperature-measuring elements arranged in a ceramic disk;

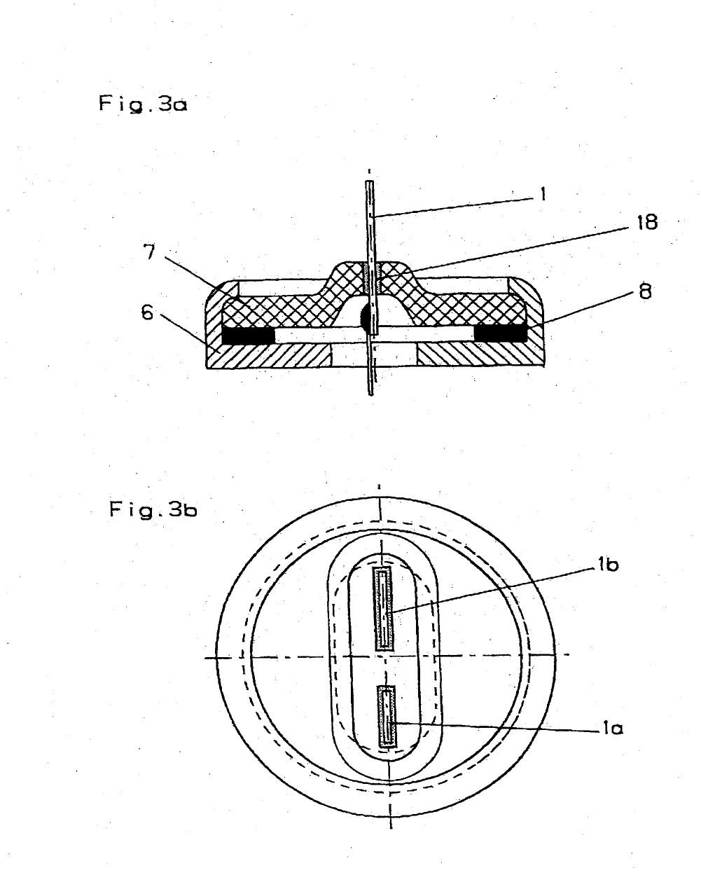

FIG. 3a shows a detail from FIG. 1 or 2 relating to an arrangement of film resistors in a ceramic disk;

FIG. 3b shows the detail from FIG. 3a in top view.

According to FIG. 1, a sensor element is produced having sealing compound or glass 18 in a carrier disk 21 made of heat-resistant and exhaust gas-resistant stainless steel. By a structured inner wall of the sealing compound space, e.g., by a thread 30, a good hold of the sealing compound is achieved. The region of the carrier disk 21, through which the sensor element passes to the medium, has rectangular contours that are only slightly larger than the sensor element cross section.

In this way, the flow sensor element is held directed into the media-guiding tube 5 and the inner space of the complete sensor is sealed against the medium.

The carrier disk 21 is inserted into a housing [tube] 24 and fused tight with a round seam 22. In the housing tube 24, the housing 11 is fused. In the housing 11, the insulating body 10 made of temperature-resistant plastic or ceramic is held with a ring 9, which is fixed by a bead 17. A cable protection sleeve [14] made of an elastomer is tightly mounted with the bead 16 on the cable outlet. Feed lines 4 are guided through the boreholes of a cable protection sleeve 14. Each feed line is connected electrically via a crimp 25 to a contact sleeve 3. The contact sleeve 3 has a widened section 26 under an insulating part 10 and above the insulating part 10 has a surface 27, which is wider than the contact sleeve diameter, so that the contact sleeve is fixed in the axial direction in the insulating part 10. On the surface 27 the connection wires 2 are contacted electrically with the weld 15.

The attachment of the complete sensor to the media-guiding tube 5 is realized by a commercially available worm drive hose clip 13 and a slotted sheet flange part 12 welded onto the media-guiding tube 5.

The orientation of the flow sensor element 1 in the tube 5 is realized by a centering pin 19, which is fixed on the housing tube 24 and by the wide slot 20 in the sheet flange part 12. Opposite a wide slot 20 there is a narrow slot 23, which serves only to be able to press the sheet flange part 12 more easily against the housing tube 24. In this way, assembly is only permitted in the correct angled position.

FIG. 2 shows another construction with a ceramic carrier disk 7, in which the flow element 1 is fixed in the carrier disk 7 with glass solder 18. The carrier disk 7 is crimped together into the metallic mounting 6 with a high temperature-resistant seal 8 made of mica or graphite. The mounting 6 is likewise welded tight with the housing tube 24.

In one embodiment as a measurement device of a flow sensor according to the hot-film anemometer principle, the heating element is constructed as a heating capacity sensor, and the temperature-measuring element as a temperature sensor, which can also carry a heat conductor for free annealing.

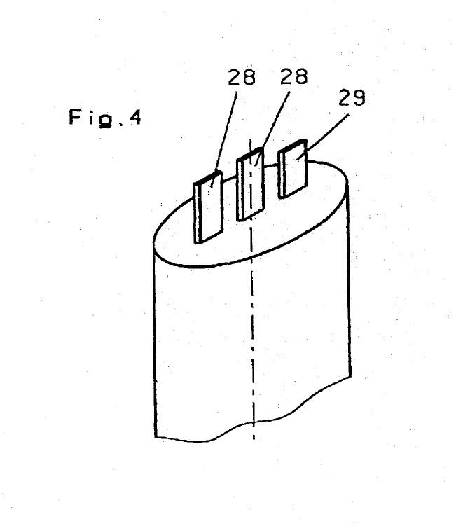

According to FIG. 4, for this purpose two heating capacity sensors 28 are arranged for identifying the direction of the media flow. The anemometric measurement principle functions, in principle, so that the temperature-measuring element detects the media temperature precisely. The one or two heating elements of the heating capacity sensor(s) 28 are then held by an electric circuit at a constant higher temperature relative to the temperature sensor 29. The gas or liquid flow to be measured cools the heating element(s) of the heating capacity sensor(s) to a greater or lesser degree.

For maintaining the constant higher temperature, the electronics must deliver for mass flow corresponding current to the heating element(s); this generates, on a precise measurement resistor, a voltage that correlates with the mass flow and can be evaluated. The double arrangement of the heating capacity sensor 28 here allows directional identification of the mass flow.

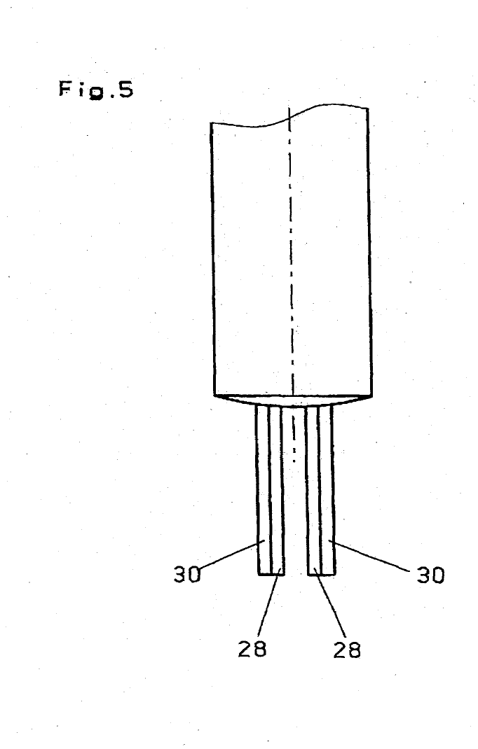

Deviating from FIG. 5, in an embodiment as a soot sensor, two heating capacity sensors are placed opposite each other in parallel in a tube housing.

The two heating capacity sensors 28 are here also provided respectively with an overglazed ceramic cover.

In the specified arrangement, one heating capacity sensor is operated above the pyrolitic incineration temperature; i.e., at about 500° C. The second heating capacity sensor is here operated in a lower temperature range of 200 to 450° C., preferably 300 to 400° C. Upon soot deposition on this second heating capacity sensor, this deposition layer acts as thermal insulation and a change of the IR emission properties in the sense of an increasing black body.

This can be evaluated electronically in a reference measurement to the first heating capacity sensor.

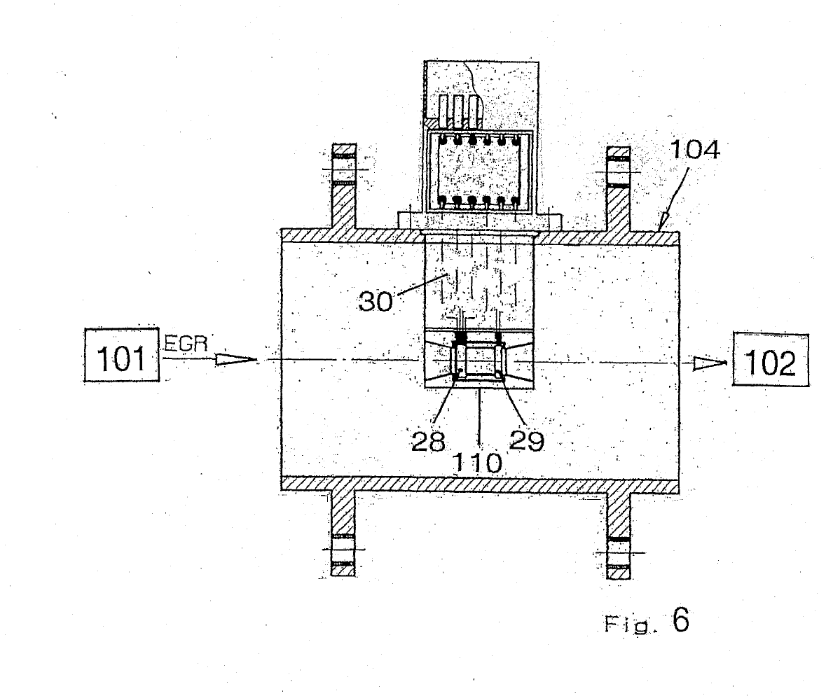

FIG. 6 shows a device for exhaust-gas recirculation from an outlet region 104 of a vehicle internal combustion engine 101 into an air inlet region 102, to which an adjustable mixture of exhaust gas and inflowing air of the machine 101 can be fed and a fuel quantity can be adjusted in which, according to the invention, in the outlet region of the internal combustion engine 104 a hot-film anemometer 110 is arranged, which has two ceramic chips 28, 29 fixed on a ceramic carrier 30, and on this carrier 30 the transition to the metallic material of the outlet region 104 of the internal combustion engine is realized, so that the current paths of the chip are electrically insulated gas-tight by the ceramic material from the metallic material in the region of the exhaust-gas outlet region 104 of the internal combustion engine. Thus, a material arrangement with different expansion coefficients between the metallic exhaust-gas tube and the ceramic chip are provided gas-tight for long-term high temperatures, by which an improved measurement is made possible.

1. Measurement device, in particular anemometric measurement device of a flow sensor, comprising film resistors in one or more opening(s) of a cover or a hollow body, wherein the film resistors are fixed in the opening(s) and wherein two film resistors differ with respect to their resistance by one to three orders of magnitude.

2. Measurement device according to claim 1, characterized in that two film resistors are held in an opening on a common ceramic substrate.

3. Measurement device according to claim 1 or 2, characterized in that two film resistors are arranged on respective ceramic substrates and the two ceramic substrates are respectively fixed in an opening.

4. Measurement device according to one of claims 1 to 3, characterized in that the base surface of the opening(s) is smaller by one to five orders of magnitude than the cover base surface.

5. Measurement device according to one of claims 1 to 4, characterized in that the cover is disk-shaped.

6. Measurement device according to one of claims 1 to 5, characterized in that the film resistors are ceramic chips, which have a conductor track applied to the ceramic and two terminal lines connected to the conductor track

7. Anemometric measurement device of a flow sensor, in particular according to one of claims 1 to 5, in which a temperature sensor and a heating capacity sensor are placed in a carrier element, characterized in that the temperature sensor has a temperature-measuring resistor and a heat conductor as platinum thin-film or thick-film resistors on a ceramic substrate.

8. Anemometric measurement device of a flow sensor according to claim 6, characterized in that the carrier element is made of temperature-resistant inorganic material (250° C., particularly >400° C. long-term temperature).

9. Anemometric measurement device of a flow sensor according to one of claims 6 or 7 for mass through flow rate measurement of gaseous or liquid media through pipe lines (5), characterized in that the temperature-measuring element and the heating element are arranged perpendicular to the carrier element.

10. Device for exhaust-gas recirculation from an outlet region (104) of a vehicle internal combustion engine (101) into an air inlet region (102), to which an adjustable mixture of exhaust gas and inflowing air of the machine (101) can be fed and a fuel quantity can be adjusted, characterized in that in the outlet region of the internal combustion engine (104) a hot-film anemometer (110) is arranged, having two ceramic chips (28, 29) fastened on a ceramic carrier (30), and on this carrier (30) the transition to the metallic material of the outlet region (104) of the internal combustion engine is realized, so that the current paths of the chip are electrically insulated gas-tight by the ceramic material from the metallic material in the region of the exhaust-gas outlet region (104) of the internal combustion engine.

11. Device according to claim 10, characterized in that the hot-film anemometer is arranged in an air-cooled cooler or before the cooling system.

12. Device according to one of claims 10 or 11, characterized in that a hot-film anemometer is arranged neither for the fresh air nor for the cooled exhaust gas.

13. Device according to one of claims 10 to 12, characterized in that it has a measurement device according to one of claims 1 to 8.

14. Method for self-cleaning of an anemometric measurement device of a flow sensor, in which a temperature-measuring element and a heating element are placed in a carrier element, characterized in that the temperature-measuring element has a platinum thin-film resistor on a ceramic substrate for temperature measurement and is heated with an additional platinum thin-film resistor.

15. Method for producing an anemometric measurement device of a flow sensor made of film resistors and a cover or a hollow body, wherein at least two film resistors, whose resistance differs by one to two orders of magnitude, are placed in openings of the cover or hollow body and are fastened in the openings.
